(19) United States
(12) Patent Application Publication
(10) Pub. No.: US 2010/0217937 A1
(43) Pub. Date: Aug. 26, 2010

(54) Data processing apparatus and method

(75) Inventors: Dominic Hugo Symes, Cambridge (GB); Jonathan Sean Callan, Cambridge (GB); Hedley James Francis, Suffolk (GB); Paul Gilbert Meyer, Bee Cave, TX (US)

Correspondence Address: NIXON & VANDERHYE P.C., 901 N. Glebe Road, 11th Floor, Arlington, VA, 22203-1808, US

(73) Assignee: ARM LIMITED, Cambridge (GB)

(21) Appl. No.: 12/379,440

(22) Filed: Feb. 20, 2009

(51) Int. Cl. G06F 12/12; G06F 12/02

(52) U.S. Cl. 711/136; 711/137; 711/E12.071; 711/E12.004

(57) ABSTRACT

A data processing apparatus is described which comprises a processor operable to execute a sequence of instructions and a cache memory having a plurality of cache lines operable to store data values for access by the processor when executing the sequence of instructions. A cache controller is also provided which comprises preload circuitry operable in response to a streaming preload instruction received at the processor to store data values from a main memory into one or more cache lines of the cache memory. The cache controller also comprises identification circuitry operable in response to the streaming preload instruction to identify one or more cache lines of the cache memory for preferential reuse. The cache controller also comprises cache maintenance circuitry operable to implement a cache maintenance operation during which selection of one or more cache lines for reuse is performed having regard to any preferred for reuse identification generated by the identification circuitry for cache lines of the cache memory. In this way, a single streaming preload instruction can be used to trigger both a preload of one or more cache lines of data values into the cache memory, and also to mark for preferential reuse another one or more cache lines of the cache memory.

### BACKGROUND OF THE INVENTION

1. Field of Invention

The present invention relates to a data processing apparatus and method for controlling a cache memory. More particularly, embodiments of the present invention relate to an apparatus and method for preloading data to cache lines of a cache memory, and controlling a cache maintenance operation for reusing cache lines of the cache memory.

2. Description of the Prior Art

In order to execute data processing operations, processors require access to data values stored in a memory. The main memory of a data processing apparatus is however relatively slow, and direct access to a main memory by a processor is therefore not practical. In order to enable faster access to data values, processors are often provided with a cache memory which mirrors a portion of the content of the main memory and can be accessed much faster by the processor. New data values are stored into the cache memory as and when required, and once these data values are present in the cache memory they can be accessed more quickly in the future, until such a time as they are overwritten. The operation of a cache memory relies on the fact that a processor is statistically more likely to reuse recent data values than to access new data values.

A cache memory comprises a plurality of cache lines (also known as rows) each being operable to store data values for access by the processor. Data values are loaded into the cache memory from the main memory in units of cache lines. As a result of the fact that a cache memory is relatively small compared with the main memory, it will be appreciated that it is frequently necessary to reuse cache lines when new data values are to be loaded into the cache memory. There are several schemes which can be applied for selecting cache lines for reuse in the event of new data values being loaded into the cache, for example a random replacement policy or a least-recently used replacement policy.

Certain types of processor operation may interfere with the effectiveness of a cache memory. For example, in the case of streaming data—where data is handled as a long stream and almost all data accesses are local to the current position in the stream which steadily advances when data is to be streamed—the cache memory can be rapidly overwritten by the stream of data values. This is disadvantageous when the stream of data values are used only once (as will usually be the case with streaming data), because non-streaming data which may have been reused in the future will be overwritten by the streamed data values which are less likely to be reused. Examples of operations which may involve this type of data streaming are codecs, communication protocols and block memory operations.

Some processor architectures (for example IA-32/SSE, Hitachi SR8000, 3DNow!) have addressed this problem using modified load and store instructions that bypass the cache memory for streamed data. Some architectures (for example IA-32/SSE) have a multi-level cache structure and provide a preload instruction that specifies to which level of cache the data should be preloaded.

A cache management method was proposed by the Applicant in previous PCT application WO-A-2007/096572 in which data traffic is monitored and data within the cache is marked for preferential eviction from the cache based on the traffic monitoring.

A cache eviction optimisation technique is described in U.S. Pat. No. B6,766,419 in which program instructions permit a software designer to provide software deallocation hints identifying data that is not likely to be used during further program execution.

A caching scheme for streaming data is described in the article “Memory Access Pattern Analysis and Stream Cache Design for Multimedia Applications” (Junghee Lee, Chanik Park and Soonhoi Ha) which provides for a separate cache to be utilised for streaming data in order to prevent the standard data cache from being overwritten.

### SUMMARY OF INVENTION

According to one aspect of the present invention, there is provided a data processing apparatus, comprising:

a processor operable to execute a sequence of instructions;

a cache memory having a plurality of cache lines operable to store data values for access by the processor when executing the sequence of instructions;

a cache controller, comprising
preload circuitry operable in response to a streaming preload instruction received at said processor to store data values from a main memory into one or more cache lines of said cache memory;
identification circuitry operable in response to said streaming preload instruction to identify one or more cache lines of said cache memory for preferential reuse; and
cache maintenance circuitry operable to implement a cache maintenance operation during which selection of one or more cache lines for reuse is performed having regard to any preferred for reuse identification generated by said identification circuitry for cache lines of the cache memory.

In this way, a single streaming preload instruction can be used to trigger both a preload of one or more cache lines of data values into the cache memory, and also to mark for preferential reuse one or more cache lines of the cache memory. Then, when new data values are to be loaded into the cache memory, the cache lines marked for preferential reuse will be considered as candidate lines for reuse, such that they will be preferentially overwritten in the place of cache lines which may contain data values which might be required in the future. Effectively, the streaming preload instruction allows a programmer to mark data as ephemeral—i.e. to be cached briefly and then discarded. For example, in one embodiment the streaming preload instruction may function as a cache hint which causes the CPU to preload the next cache line and mark the previous cache line as evictable. In another embodiment, the streaming preload instruction may function as a cache hint which causes the CPU to both preload and mark the next cache line as evictable.

Preferably, the previous cache line is marked as preferred for reuse, or evictable, rather than the current cache line due to the fact that the CPU may not have finished accessing data in the current cache line, and therefore the data values stored in the current cache line may still be required.

The cache maintenance operation may for example be a line fill operation whereby a line of data values in a main memory are copied into a line of the cache memory.

This instruction can also be used in conjunction with a streaming evict instruction which is a cache hint which causes the CPU to mark the previous cache line as evictable (without simultaneously triggering a preload operation). A streaming evict operation would thus be useful at the end of a streaming process for example, when no further data values within the stream are required to be preloaded for processing.

The streaming preload instruction preserves space in the data cache for data that will be reused, which in turn may increase performance and decrease power consumption, albeit at the cost of a requirement for new instructions to be inserted into streaming code, and an increase in cache complexity.

A typical streaming application might be constructed as follows:

### Loop:

Read data from address A

Process data

Write data to address B

Increment A and B

While more data Go to Loop

It will be appreciated that after a few thousand iterations this is likely to overwrite the entire data cache.

However, adding the new instructions as follows:

### Loop:

Preload Streaming Data (address A)

Read data from address A

Process data

Pre-evict Streaming Data (address B)

Write data to address B

Increment A and B

While more data Go to Loop

This modified code provides that only a fraction of the data cache is overwritten, rather than every way of the cache.

The streaming preload instruction may specify a memory address corresponding to a current cache line within the cache memory which is currently being processed by the processor. In this case, the preload circuitry is operable to store into one or more cache lines of the cache memory data values within the main memory which follow the data values in the current cache line, and the identification circuitry is operable to identify for preferential reuse one or more cache lines of the cache memory containing data values from the main memory preceding the data values in the current cache line. In this way, the streaming preload instruction needs only to specify a single memory address, and the cache controller is then able to referentially apply the preload and mark for preferential reuse operations based on the single memory address. This provides simplicity compared with an arrangement in which separate instructions and respective target addresses are provided to preload a cache line and mark another cache line for preferred eviction. A conventional preload instruction specifies the address of a cache line to be preloaded, whereas embodiments of the present invention specify a memory address of a current position within a stream of data, and target addresses for preloading and marking for preferred use are generated referentially from that current position.

Alternatively, the streaming preload instruction may point to a processor register which stores a pointer to the memory address of a data value currently being processed, and the memory address stored in the processor register can then be used to specify the reference point for referentially determining the cache lines to be preloaded and marked for preferential reuse.

The streaming preload instruction may specify an amount of streaming data to be available in the cache memory. In this case, the preload circuitry is operable to preload into the cache memory an amount of data from the main memory determined in accordance with the amount of streaming data specified in the streaming preload instruction. For example, the streaming preload instruction may specify that plural cache lines of data values are to be preloaded into the cache from the main memory. Similarly in this case, the identification circuitry may be operable to identify for preferential reuse a number of cache lines determined in accordance with the amount of streaming data specified in the streaming preload instruction.

In other words, flexibility can be provided in the amount of data which is preloaded and marked for reuse by requesting a desired amount of data in the streaming preload instruction, depending for example on the memory latency, or the number of outstanding memory requests the memory system supports.

There are a number of possible methods for marking data values in the cache for preferential reuse. For example, cache lines of a cache memory will typically have associated therewith a valid bit which is used to indicate whether the cache line contains valid data. The identification circuitry may be operable to set the valid bit of a cache line to indicate that the cache line does not contain valid data if that cache line is preferred for reuse. Then the cache maintenance circuitry will be operable to preferentially select for reuse cache lines having a valid bit which is set to indicate that that cache line does not contain valid data. This arrangement is advantageous because it utilises an existing flag in the cache memory and thus does not require the addition of any additional flags to the cache lines of the cache.

In an alternative arrangement, each of the cache lines of the cache memory has associated therewith a preferred for reuse field (additional to the valid bit) which is set in dependence on the preferred for reuse identification produced by the identification circuitry. In this case, the cache maintenance circuitry is operable to preferentially select for reuse cache lines having a preferred for reuse field which is set to indicate that that cache line is preferred for reuse. An advantage of providing a dedicated preferred for reuse flag (rather than making use of the valid bit), is that data can remain valid (and thus accessible in the cache) at the same time as being marked as preferred for reuse.

The cache memory may be an n-way set associative cache memory. In this case, the cache maintenance circuitry is operable to select between n corresponding cache lines of the respective n ways for reuse having regard to any preferred for reuse identification generated by the identification circuitry for any of the one or more of the n corresponding cache lines of the cache memory.

A streaming data lookup table may be provided which is operable to store an association between lines of data values which have been previously cached in response to a streaming preload instruction and an indication of in which of the n ways those lines of data values were cached. In this case, the preload circuitry is operable to add an entry in the streaming lookup table to indicate to which way of the cache memory the preloaded data values have been stored. Furthermore, the identification circuitry is operable in response to the streaming preload instruction to locate the cache line of data values within the cache memory using the streaming data lookup table and identify the located cache line for preferential reuse. This arrangement simplifies the process of marking cache lines for preferential reuse, because it is not necessary to search each way of the cache for the appropriate entry.

In an alternative arrangement, where a lookup table is not provided, the identification circuitry is operable to locate the cache lines of data values within the cache memory by searching each way of the cache memory for a cache line corresponding to the address of the one or more data values stored in the cache line.

A different form of streaming data lookup table may also be provided which stores an association between previously cached lines of data values and an indication of in which of the n ways the lines of data values were cached. In this case, the identification circuitry (rather than the preload circuitry) is operable to add an entry in the streaming lookup table to indicate to which way of the cache memory the preloaded data values have been stored. The cache maintenance circuitry is then operable when conducting a cache maintenance operation to select between n corresponding cache lines of the respective n ways for reuse having regard to any entries in the streaming lookup table indicating preferred reuse of any of the one or more of the n corresponding cache lines of the cache memory. In other words, this form of streaming data lookup table is used to provide the preferred for reuse indication rather than to provide a shortcut way for the identification circuitry to locate a recently used way of the cache.

One potential problem with this technique is that it would be possible for a cache line in the streaming data lookup table to be overwritten by new data before the processor has finished with it. To reduce the likelihood of this happening, the cache maintenance circuitry may have regard to the least recently added entries in the streaming lookup table in selecting between the n corresponding cache lines of the respective n ways for reuse. In this way, the most recently added entries (those which are most likely to still be in use) will not be considered as preferred for reuse, thereby reducing the likelihood of data values which are currently being processed being overwritten.

The preload circuitry may be operable to store into the cache memory data values corresponding to a portion of main memory containing the address

P_{add}=A_{curr}+x×Cₛ

and the identification circuitry may be operable to identify for preferential reuse one or more cache lines of said cache memory containing data values corresponding to a portion of memory containing the address

R_{add}=A_{curr}−y×Cₛ

where P_{add} represents a memory address within the portion of main memory to be preloaded into the cache memory in the preload operation, R_{add} represents a memory address corresponding to a cache line to be identified for reuse in the reuse identification operation, A_{curr} represents the memory address specified in the streaming preload instruction, Cₛ represents the length of each cache line in the cache memory, and x and y are integers.

The values x and/or y may be predetermined constants, and may also take on plural values where multiple cache lines are to be stored and/or marked for preferential reuse. For example, the value x may be 1 and 2, indicating that the two cache lines immediately following a cache line currently being processed are to be preloaded. Similarly, the value y may be 1 and 2, indicating that the two cache lines immediately preceding the cache line currently being processed are to be marked for preferential reuse.

Alternatively, the values x and/or y may be specified in the streaming preload instruction itself, giving the programmer the capability to determine how much, and which, streaming data is to be preloaded into the cache or marked for possible eviction from the cache.

In some architectures, a hierarchy of cache memories are provided, with a smaller, faster cache memory being accessed first, and a larger, slower (but still faster than main memory) cache memory being accessed if data is not present in the smaller cache memory. In the context of embodiments of the present invention, it will be appreciated that a further cache memory can be provided between the main memory and the cache memory, the further cache memory having substantially the same structure as the cache memory. In particular, the further cache memory may comprise a plurality of cache lines operable to store data values for transfer to the cache memory and access by the processor when executing the sequence of instructions. The streaming preload instruction may specify in this case in respect of which of the cache memory and the further cache memory the preload operation and the eviction identification operation are to be conducted.

In this case, the cache controller may be operable, where the streaming preload instruction specifies that the preload operation and the reuse identification operation are to be conducted in respect of the cache memory, to preload data values into cache lines of the cache memory, and mark for preferential reuse one or more cache lines of the cache memory. Also, the cache controller may be operable, in the case that said streaming preload instruction specifies that the preload operation and the reuse identification operation are to be conducted in respect of the further cache memory, to preload data values into cache lines of the further cache memory, and mark for reuse one or more cache lines of the further cache memory.

It will be appreciated that a single cache controller could be used to control both the cache memory and the further cache memory, or alternatively each of the cache memories could be provided with its own dedicated cache control circuitry.

The streaming preload instruction may be executable by application software running on the data processing system in an unprivileged mode. Typically, a processor will have both privileged and unprivileged modes. Many cache maintenance program instructions can only usually be conducted in the privileged mode. An advantage of the streaming preload instruction is that it can be used by an application in the unprivileged mode.

According to another aspect of the present invention, there is provided a data processing apparatus, comprising:

processing means for executing a sequence of instructions;

cache memory means having a plurality of cache lines for storing data values for access by the processing means when executing the sequence of instructions;

cache control means, comprising
preload means for storing data values from a main memory into one or more cache lines of said cache memory means in response to a streaming preload instruction received at said processing means;
identification means for identifying one or more cache lines of said cache memory means for preferential reuse in response to said streaming preload instruction; and
cache maintenance means for implementing a cache maintenance operation during which selection of one or more cache lines for reuse is performed having regard to any preferred for reuse identification generated by said identification means for cache lines of the cache memory means.

According to another aspect of the present invention, there is provided a method of operating a cache memory having a plurality of cache lines for storing data values for access by a processor when executing a sequence of instructions, comprising the steps of:

storing data values from a main memory into one or more cache lines of said cache memory in response to a streaming preload instruction received at said processor;

identifying one or more cache lines of said cache memory for preferential reuse in response to said streaming preload instruction; and

implementing a cache maintenance operation during which selection of one or more cache lines for reuse is performed having regard to any preferred for reuse identification generated by said identifying step for cache lines of the cache memory.

Various other aspect and features of the present invention are defined in the claims, and include a computer program product.

The above, and other objects, features and advantages of this invention will be apparent from the following detailed description of illustrative embodiments which is to be read in connection with the accompanying drawings.

### BRIEF DESCRIPTION OF THE DRAWINGS

Embodiments of the invention will now be described, by way of example only, with reference to the accompanying drawings in which:

FIG. 1 schematically illustrates a data processing apparatus having a main memory and level 1 and level 2 cache memories;

FIG. 2 schematically illustrates a stream of data to be cached and operated on by a processor;

FIG. 3 schematically illustrates a cache memory;

FIG. 4 schematically illustrates an alternative cache memory;

FIG. 5 is a schematic flow diagram illustrating a process for preloading data values into a cache memory and marking cache lines of the cache memory for preferred reuse; and

FIG. 6 is a schematic flow diagram illustrating a process for performing a cache line update when a data value is to be accessed by a processor.

### DESCRIPTION OF PREFERRED EMBODIMENTS

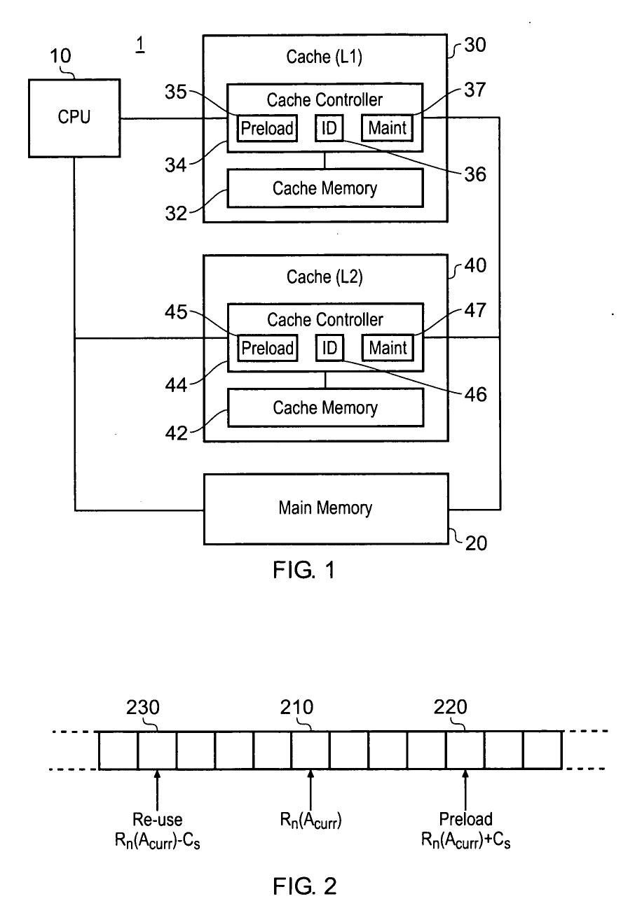

Referring to FIG. 1, a data processing apparatus 1 is schematically illustrated. The data processing apparatus 1 comprises a central processing unit 10 for executing data processing instructions, a main memory 20 for storing data, and cache memories 30, 40 for temporarily storing data values for use by the central processing unit 10. The main memory 20 provides large volume, but slow access, storage. In order to enable faster access to data, a copy of a subset of the data stored in the main memory 20 is stored in a level 2 cache 40. The level 2 cache 40 provides much smaller volume storage than the main memory 20, but can be accessed much more quickly. In addition, a level 1 cache 30 is also provided in this case, which in turn provides smaller volume storage than the level 2 cache 40, but at a faster access time.

When the central processing unit 10 requires a particular data value, the level 1 cache 30 is checked first (because it provides the fastest possible access to a data value if that data value is in fact present in the level 1 cache 30), and if it is present in the level 1 cache 30 (a level 1 cache hit), the data value will be read and used by the central processing unit 10. In this case, there will be no need to access either the level 2 cache 40 or the main memory 20. However, if the data value is not present in the level 1 cache 30 (a level 1 cache miss), the level 2 cache 40 is then checked, and if the data value is present (a level 2 cache hit), it will be read and used by the central processing unit 10. In this case, both the level 1 cache 30 and the level 2 cache 40 will need to be accessed, but there will be no need to access the main memory 20. Only in the event that the required data value is present neither in the level 1 cache 30 or the level 2 cache 40 (level 2 cache miss) will it be necessary to access the main memory 20 to obtain the data value.

The level 1 cache 30 comprises a cache memory 32 which stores data values in units of cache lines, and a cache controller 34 which controls access to the cache memory 32 by the central processing unit 10. The cache controller 34 comprises preload circuitry 35 which is responsive to a streaming preload instruction being executed by the central processing unit 10 to store lines of data values from the main memory 20 into one or more cache lines of the cache memory 32. The cache controller 34 also comprises identification circuitry 36 which is responsive to the streaming preload instruction to identify one or more cache lines of the cache memory 32 for preferential reuse, and cache maintenance circuitry 37 which is operable to implement a cache maintenance operation during which selection of one or more cache lines for reuse is performed having regard to any preferred for reuse identification generated by said identification circuitry 36 for cache lines of the cache memory 32.

As with the level 1 cache 30, the level 2 cache 40 comprises a cache memory 42 which stores data values in units of cache lines, and a cache controller 44 which controls access to the cache memory 42 by the central processing unit 10. The cache controller 44 comprises preload circuitry 45 which is responsive to a streaming preload instruction being executed by the central processing unit 10 to store data values from the main memory 20 into one or more cache lines of the cache memory 42. The cache controller 44 also comprises identification circuitry 46 which is responsive to the streaming preload instruction to identify one or more cache lines of the cache memory 42 for preferential reuse, and cache maintenance circuitry 47 which is operable to implement a cache maintenance operation during which selection of one or more cache lines for reuse is performed having regard to any preferred for reuse identification generated by the identification circuitry 46 for cache lines of the cache memory 42.

In this way, program code including the streaming preload instruction can be used to cause data values to be preloaded into both the level 1 cache 30 and the level 2 cache 40 from the main memory 20, and also to cause cache lines of the cache memories 32, 42 of each of the level 1 cache 30 and the level 2 cache 40 to be marked for preferential reuse, thereby reducing the problem of streaming data overwriting useful data in the caches. It will be appreciated that variants of this technique could be applied to preload and mark for preferential reuse only in respect of one or other of the level 1 cache 30 and the level 2 cache 40.

The cache memory may be an n-way set associative cache memory. This means that the cache memory is logically divided into n (n being a positive integer, for example 4) sections, or ways. Each way of the cache memory comprises a set of cache lines, each cache line of each way having an index value, and being associated with a corresponding cache line of each of the other ways. The associated cache lines of each way each have the same index value. When data values from main memory are to be stored into the cache memory, they will be allocated to a cache line in dependence upon the memory address corresponding to the location in main memory of the data values to be stored. Any given line of data values from the main memory can be stored into a cache line having a particular index value, and can thus be stored into one particular cache line of any one of the n ways of the cache memory. The greater the value of n, the less the likelihood of a cache miss, but the greater the amount of processing required in order to access data values in the cache (because a particular line of data values can be stored to a greater number of cache lines, necessitating the checking of a larger number of cache lines of the cache for a given data value).

The general form for a cache entry is as follows:

| | | |
|---|---|---|
| Data values | TAG | Valid bit |

The data values are those fetched from main memory, or stored into the cache memory by the processor prior to subsequent storage back into the main memory. The TAG, together with an index and displacement define the memory address of the main memory to which the data values correspond. In particular, the Most Significant Bits (MSBs) of the memory address form the TAG, the middle bits form the index, and the Least Significant Bits form the displacement. For example, in the case of a 32-bit memory, the TAG may comprise the first 20 bits of the memory address, the index may comprise the next 7 bits of the memory address, and the displacement may comprise the last 5 bits of the memory address. Finally, the valid bit indicates whether the cache line contains valid data.

Effectively, the values which are actually stored in the cache are the data values, the TAG address, the valid bit, and optionally (as will be discussed below) a preferred for reuse flag. The index is represented by the position of a cache line within the array of cache lines which make up a way of the cache memory, and is thus unique to a single line (in each way) of the cache, and this value therefore represents the line of the cache in which the data has been put, or is to be put. The displacement represents the position within the stored cache line (usually used to indicate which of several blocks of data values in the cache line are required). The TAG address is stored in the cache line in association with the data values, and on a cache access is checked against the MSBs of the memory address to determine whether the desired data values are present within the cache. In particular, the TAG is used to determine to which way (if any) of the cache a particular line of data values has been stored.

Referring to FIG. 2, a representation of a stream of data values is schematically illustrated. A position 210 in the data stream at which processing by the central processing unit 10 is currently taking place has an address A_{curr}, and this address is stored in a register Rₙ within the central processing unit 10. A cache line of the data values including the data value at the address A_{curr} is present in the level 1 cache 30. The preload circuitry 35 is responsive to the streaming preload instruction to calculate, based on the current address A_{curr} stored in the processor register Rₙ, a cache line of data values to be preloaded into the level 1 cache 30. In the present case, the cache line to be preloaded includes the memory address:

P_{add}=A_{curr}+x×Cₛ (Eq 1)

where P_{add} represents a memory address within the portion of main memory to be preloaded into the cache memory in the preload operation, A_{curr} represents the current address within the data stream at which processing is currently taking place, which may be specified in the streaming preload instruction, Cₛ represents the length of each cache line in the cache memory, and x is an integer.

In particular, the preload circuitry 35 determines the memory address of the lines of data values to be preloaded by adding the size of one or more cache lines (the number of cache lines depending on the value of x) to the current address, and preloading a line of data values from a portion of memory containing the thus calculated address. It will be appreciated that this determination may be made in a number of ways. For example, the current address might represent the start address of a cache line currently being processed, or the end address of the cache line currently being processed, or any other address within the cache line which is currently being processed. In the case where the current address indicates the start position of the cache line currently being processed, the above equation (Eq. 1) will directly determine the start address of the line of data values to be preloaded. In the case where the current address indicates another position within the cache line currently being processed, the above equation (Eq. 1) will provide a memory address of a position within the line of data values to be preloaded, requiring an additional operation to determine the start position of the line of data values to be preloaded.

Additionally, the identification circuitry 36 is responsive to the streaming preload instruction to calculate, based on the current based on the current address A_{curr} stored in the processor register Rₙ, a memory address of a cache line within the level 1 cache 30 to be marked for preferred reuse. In the present case, the cache line to be marked for preferred reuse includes the memory address:

R_{add}=A_{curr}−y×Cₛ (Eq. 2)

where R_{add} represents a memory address corresponding to a cache line to be identified for preferential reuse in the reuse identification operation, A_{curr} represents the current address within the data stream at which processing is currently taking place, which may be specified in the streaming preload instruction, Cₛ represents the length of each cache line in the cache memory, and y is an integer.

In particular, the preload circuitry 35 determines the cache line to be marked for preferential reused by subtracting the size of one or more cache lines (the number of cache lines depending on the value of y) from the current address, and marking for preferential reuse the cache line containing data values associated with the thus calculated address. As with the determination of the preload address as discussed above, it will be appreciated that the determination of the cache line(s) for preferred reuse may be made in a number of ways. For example, the current address might represent the start address of data values within a cache line currently being processed, or the end address of data values within the cache line currently being processed, or an address of data values in the middle of the cache line which is currently being processed. In the case where the current address indicates the start position of the cache line currently being processed, the above equation (Eq. 2) will directly determine the start address of the cache line to be marked for preferred reuse. In the case where the current address indicates another position within the cache line currently being processed, the above equation (Eq. 2) will provide a memory address within the cache line to be marked for preferred reuse, requiring an additional operation to determine the start position of the cache line.

In this way, the current memory address A_{curr} is used to define data to be preloaded, and data to be discarded.

It will be appreciated that, by virtue of the fact that a cache line can be identified by the first 27 bits (TAG+index) of the memory address of the data values present in, or to be placed in, the cache line, and that the first 27 bits of the memory address will therefore be the same for all data values provided within that cache line, the start address of a cache line, and thus the identification of the cache line, can be conducted by taking only the first 27 bits of P_{add} and R_{add} respectively for the preload start address and the mark for preferential reuse start address. In other architectures, the number of bits taken may differ, but the principle of operation will still apply.

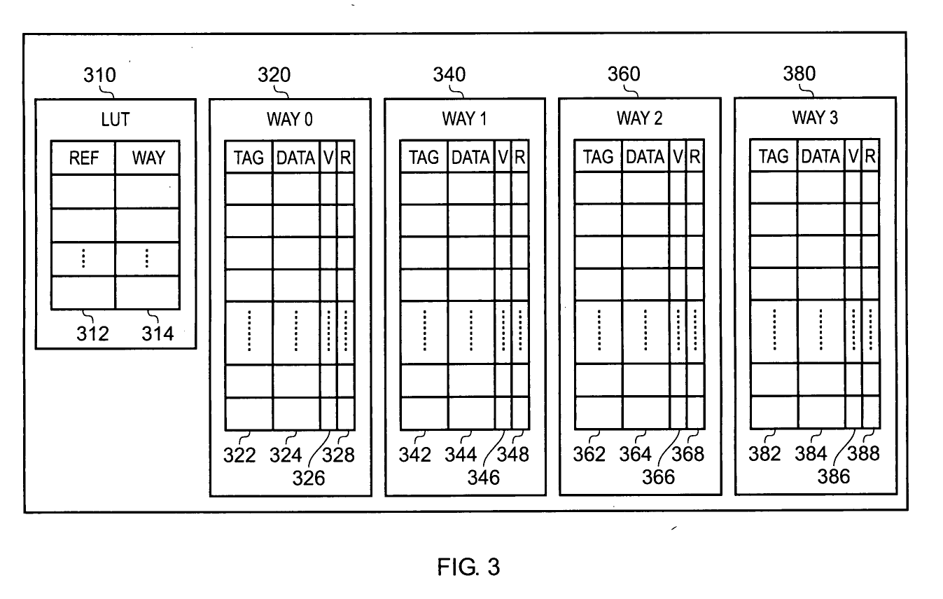

Referring to FIG. 3, an example cache memory structure is schematically illustrated. The cache memory comprises four cache ways 320, 340, 360, 380 as described above, and a lookup table 310 for identifying in which way of the cache memory lines of data values recently cached in response to a streaming preload instruction have been stored.

The first way (Way 0) 320 of the cache memory comprises a first plurality of cache lines, each having a TAG portion 322, a data portion 324, a valid flag 326 and optionally a preferred for reuse flag 328. The second way (Way 1) 340 of the cache memory comprises a second plurality of cache lines, each having a TAG portion 342, a data portion 344, a valid flag 346 and optionally a preferred for reuse flag 348. The third way (Way 2) 360 of the cache memory comprises a third plurality of cache lines, each having a TAG portion 362, a data portion 364, a valid flag 366 and optionally a preferred for reuse flag 368. Finally, the fourth way (Way 3) 380 of the cache memory comprises a fourth plurality of cache lines, each having a TAG portion 382, a data portion 384, a valid flag 386 and optionally a preferred for reuse flag 388. In the case of a write-back cache each cache line of each way will also have a dirty flag (not shown) for indicating that the value stored in the cache line has been changed but has not been written to the main memory.

Each of the first, second, third and fourth plurality of cache lines comprises the same number of cache lines, and each line of each way has an associated index which is the same as the index of a corresponding line of each of the other ways. The TAG portion stores the MSBs of a memory address corresponding to the data values stored in the data portion, and is used to locate the data values within the cache. The valid bit of each cache line identifies whether valid data is stored in the data portion. As described above, the valid flag can be set in response to the streaming preload instruction to mark a cache line of data as invalid and thus preferred for reuse. The preferred for reuse flag can optionally be provided (instead of using the valid bit) to explicitly indicate that the cache line is preferred for reuse, the preferred for reuse flag being set in response to the streaming preload instruction.

The streaming data lookup table 310 is operable to store an association between previously cached lines of data values (in particular those cached in response to a streaming preload instruction) and an indication of in which of the n ways those lines of data values were cached. In particular, the streaming data lookup table 310 comprises a plurality of rows, each having a reference portion 312, and a way-indicating portion 314. When a data value is preloaded into a cache line of, for example, the first way 320 in response to a streaming preload instruction, the streaming data lookup table 310 is updated to indicate in the reference portion 312 an identification of the cache line, and to indicate in the way-indicating portion 314 that the stored data values of that cache line can be found in the first way 320. The same process can be used to keep a record of the location of preloaded data values in each of the second, third and fourth ways. The identification of the cache line provided in the reference portion 312 may for example be the index of the cache line and a few bits of the TAG value stored in the cache line.

When a cache line is to be marked for preferential reuse in response to the streaming preload instruction, the identification circuitry is then able to compare a portion of the memory address corresponding to the cache line to be marked for preferred reuse with the reference portion 312 of the streaming data lookup table 310. In this way, it is determined whether streaming data has been recently stored into that cache line, and if so, to which way of the cache the streaming data was stored. The cache line of the way indicated in the streaming data lookup table 310 can then be marked as preferred for eviction by the identification circuitry, by setting the valid bit or preferred for reuse flag as described above.

It will be appreciated that the streaming data lookup table as described above is an optional (but advantageous) mechanism to avoid (or at least reduce) a need for the identification circuitry to look in each of the four ways to find a cache line to mark for preferred reuse. It should also be noted that the lookup table 310 is only a small cache of the most recent entries, and will generally be much smaller than the cache ways 320 to 380. It will also be appreciated that if the required cache line is not present in the streaming data lookup table, the identification circuitry may optionally check each way of the cache to determine into which way the cache line to be marked for preferred reuse was stored.

Similarly, in the case where the streaming data lookup table described above is not provided, the identification circuitry simply determines the index corresponding to the cache line to be marked for preferred reuse, and checks the TAG portion of each way of the cache against the TAG portion of the memory address of the data values which were previously stored at that index and which can now be overwritten. If a match is found, the matching cache line is marked for preferred reuse.

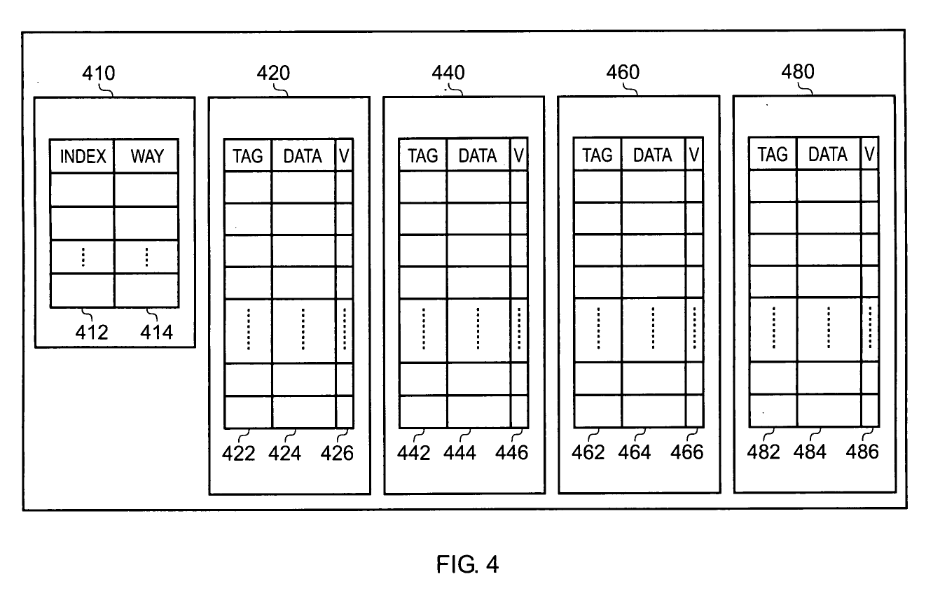

Referring to FIG. 4, a cache structure utilising an alternative form of streaming data lookup table is schematically illustrated. As with FIG. 3, the cache memory of FIG. 4 comprises four cache ways 420, 440, 460, 480 as described above, and a lookup table 410 for identifying in which way of the cache memory lines of data values recently cached in response to a streaming preload instruction have been stored.

The first way (Way 0) 420 of the cache memory comprises a first plurality of cache lines, each having a TAG portion 422, a data portion 424 and a valid flag 426. The second way (Way 1) 440 of the cache memory comprises a second plurality of cache lines, each having a TAG portion 442, a data portion 444 and a valid flag 446. The third way (Way 2) 460 of the cache memory comprises a third plurality of cache lines, each having a TAG portion 462, a data portion 464 and a valid flag 466. Finally, the fourth way (Way 3) 480 of the cache memory comprises a fourth plurality of cache lines, each having a TAG portion 482, a data portion 484 and a valid flag 486. As with FIG. 3, in the case of a write-back cache each cache line in each way will also have a dirty flag (not shown) for indicating that the value stored in the cache line has been changed but has not been written to the main memory. The structure and operation of the TAG portions, data portions and valid bits of each of the cache lines is as described above with reference to FIG. 3. However, in FIG. 4 neither the valid bit nor an optional preferred for reuse flag are used to indicate that a cache line is preferred for reuse. Instead, the streaming data lookup table 410 performs this function.

As with FIG. 3, the streaming data lookup table 410 is operable to store an association between previously cached lines of data values (in particular those cached in response to a streaming preload instruction) and an indication of in which of the n ways those lines of data values were cached. In particular, the streaming data lookup table 410 comprises a plurality of rows, each having an index portion 412, used to indicate that streaming preloaded data has been stored into the cache at that index position, and a way-indicating portion 414, used to indicate into which way of the cache (at that index) the streaming preloaded data has been stored. When a data value is preloaded into a cache line of, for example, the first way 420 in response to a streaming preload instruction, the streaming data lookup table 410 is updated to indicate in the index portion 412 the index of the cache line being preloaded (and thus the row position in the cache to which the line of data values is preloaded), and to indicate in the way-indicating portion 414 an indication that the stored data values can be found in the first way 420. The same process can be used to keep a record of the location of preloaded data values in each of the second, third and fourth ways.

When cache lines are to be reused by the cache maintenance circuitry, the cache maintenance circuitry refers to the streaming data lookup table 410 to determine whether the index of the cache line (of each way) to be considered for reuse is present in the table, and if so, to determine which way of the cache at that index position is preferred for reuse. Accordingly, the streaming data lookup table of FIG. 4 serves as the preferred for reuse identification in the place of the valid bit or preferred for reuse flag of FIG. 3.

Optionally, the most recently added entries of the streaming data lookup table 410 can be ignored for the purpose of determining a cache line to be preferred for reuse, to reduce the likelihood of a recently added entry, relating to a cache line which is likely to be in current use by the processor, being overwritten by a cache maintenance operation. There are a number of ways in which this could be implemented. For example, the entries in the lookup table could be in the form of a list ordered by age, and entries at certain positions in the list (in particular at or near the end of the list to which new entries are added) could be disregarded for the purpose of selecting cache lines for reuse.

When an entry in the streaming data lookup table of FIG. 4 has been used by the cache maintenance circuitry to select and reuse a cache line, it is desirable that this entry be removed from the table to reduce the likelihood of that cache line being reused preferentially in the future (when it in fact no longer contains the streamed data). The entry could either be deleted entirely, or marked within the streaming data lookup table as obsolete.

While the streaming lookup table 410 is illustrated as a table storing a plurality of lines each having an index portion and a way portion, it would also be possible to use a simple array of way values arranged by index.

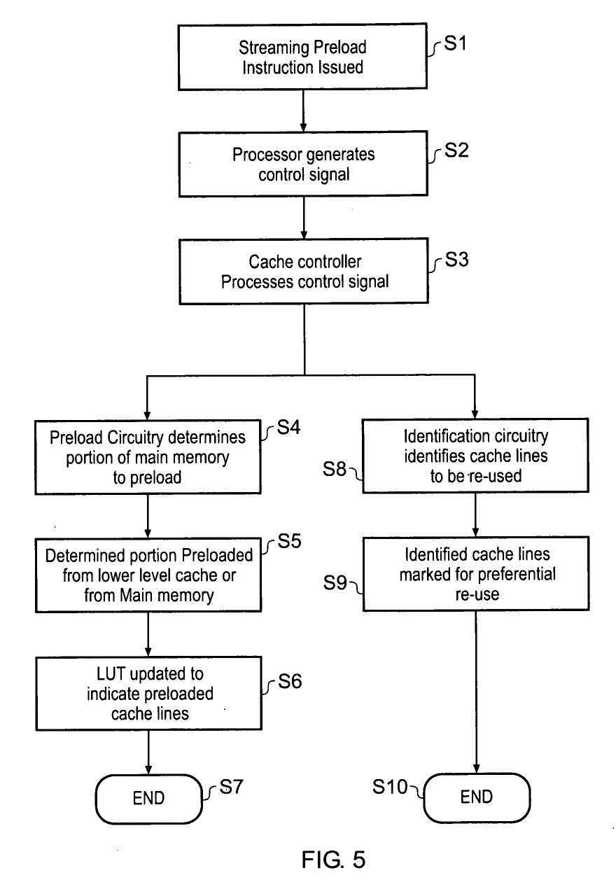

Referring to FIG. 5, an example operation of the cache controller in response to the issuance of a streaming preload instruction is schematically illustrated. First, at a step S1, a streaming preload instruction provided within currently executing program code is issued and executed by the processor. At a step S2, the processor generates control signals based on the streaming preload instruction for controlling the preloading of data values from the main memory into the cache memory, and for controlling the marking of cache lines within the cache memory for preferential reuse. At a step S3, the cache controller initiates a preload sequence represented in FIG. 4 by steps S4, S5, S6 and S7, and also an identify for reuse sequence represented in FIG. 4 by steps S8, S9 and S10.

In particular, at the step S4, the preload circuitry of the cache controller determines from the control signals generated by the processor a portion of the main memory (or a lower level cache) to be preloaded into the cache memory. As described above, the memory address of the data values to be preloaded are determined referentially based on a current memory address within a stream of data values currently being processed. Then, at the step S5, the determined portion of the main memory (or lower level cache) is preloaded into the cache memory. A streaming data lookup table (LUT) is then updated at the step S6 to indicate the cache lines which have been preloaded at the step S5. The preload sequence terminates at the step S7.

The identify for reuse sequence may be conducted either in parallel with the preload sequence, or alternatively before or after the preload sequence. In either case the identify for reuse sequence and the preload sequence are both triggered by the streaming preload instruction. In the identify for reuse sequence, at the step S8, the identification circuitry determines from the control signals generated by the processor one or more cache lines within the cache memory which are preferred for reuse. As described above, the memory address of the data values to be marked for preferred reuse are determined referentially based on a current memory address within a stream of data values currently being processed. The identified cache lines are then marked for preferential reuse at the step S9. This marking may take the form of either the setting of a flag in a preferred for reuse field of the cache line, or may take the form of setting the valid flag of the cache line to indicate that the cache line does not contain valid data (and thus can be reused). Furthermore, when a streaming data lookup table is used to provide the preferred for reuse indication, the table is updated with an entry corresponding to the cache line to be marked for preferred reuse (which may be the cache line being preloaded). The identify for reuse sequence terminates at the step S10.

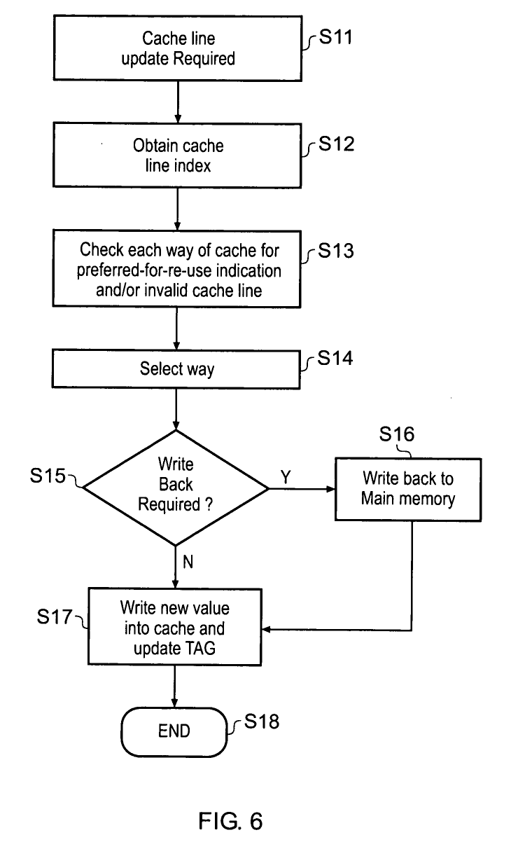

Referring to FIG. 6, an example operation of the cache controller when the cache memory is to be updated with new data is schematically illustrated. At a step S11, the cache controller determines that a cache line update is required. This may be caused either due to a cache miss when the processor attempts to access a data value in the cache memory, or in response to an instruction to write a data value generated by the processor into the cache memory. At a step S12, the cache line index corresponding to the data values to be stored into the cache memory is obtained. As described above, the cache index corresponds to a particular portion of the memory address corresponding to the data value (that is, the memory address where the data value is stored or is to be stored within main memory). In the case of a four-way set associative cache memory as shown in FIG. 3, a line of data values having a particular index can be stored to any one of four cache lines—one eligible cache line per way of the cache. At a step S13, each way of the cache is checked to determine whether a preferred for reuse indication has been applied to the cache line having the particular index. As an alternative, where the streaming data lookup table is providing the function of indicating which cache lines are preferred for reuse, the streaming data lookup table is referred to in order to determine whether a particular way of the cache is preferred for reuse in relation to that index. A cache way, and thus a cache line, into which the line of data values is to be stored is then selected at a step S14 based on the determination made at the step S13. In particular, the cache line of a cache way in respect of which a preferred for reuse indication has been applied is preferentially selected over one for which no preferred for reuse indication has been applied.

Once a cache line into which the data values are to be stored has been selected at the step S14, it is determined at a step S15 whether a write back to main memory is required in respect of the data values currently stored in the selected cache line. In a write-back cache, data values are only returned to main memory when they are evicted from the cache memory, and it is for this reason that the step S15 is required. This step is not required for a write-through cache in which an update of a data value in the cache memory is also reflected in the main memory by updating the data value also in the main memory.

The step S15 is carried out by determining whether a dirty flag has been set in relation to the cache line to be evicted. The dirty flag is set by the cache controller at the time when data values within the cache line are changed, to indicate that those changes need to be reflected in the main memory upon the reuse of the cache line. In the event that it is determined at the step S15 that the dirty flag has been set, the process moves on to a step S16 where the line of data values currently present in the cache line to be reused is stored into the main memory. At a step S17, the new line of data values are written into the selected cache line, and the TAG part of the cache line is updated accordingly. The cache line updating process terminates at a step S18.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A data processing apparatus, comprising:
(i) a processor operable to execute a sequence of instructions;
(ii) a cache memory having a plurality of cache lines operable to store data values for access by the processor when executing the sequence of instructions;
(iii) a cache controller, comprising
preload circuitry operable in response to a streaming preload instruction received at said processor to store data values from a main memory into one or more cache lines of said cache memory;
identification circuitry operable in response to said streaming preload instruction to identify one or more cache lines of said cache memory for preferential reuse; and
cache maintenance circuitry operable to implement a cache maintenance operation during which selection of one or more cache lines for reuse is performed having regard to any preferred for reuse identification generated by said identification circuitry for cache lines of the cache memory.

2. A data processing apparatus according to claim 1, wherein
(i) said streaming preload instruction specifies a memory address corresponding to a current cache line within said cache memory containing data values which are currently being processed by said processor;
(ii) said preload circuitry is operable to store into one or more cache lines of said cache memory data values within said main memory which follow the data values in the current cache line; and
(iii) said identification circuitry is operable to identify for preferential reuse one or more cache lines of said cache memory containing data values from said main memory preceding the data values in the current cache line.

3. A data processing apparatus according to claim 1, wherein
(i) said streaming preload instruction specifies a amount of streaming data to be available in the cache memory; and
(ii) said preload circuitry is operable to preload into said cache memory an amount of data from said main memory determined in accordance with said amount of streaming data specified in said streaming preload instruction.

4. A data processing apparatus according to claim 1, wherein
(i) said streaming preload instruction specifies an amount of streaming data to be available in the cache memory; and
(ii) said identification circuitry is operable to identify for preferential reuse a number of cache lines determined in accordance with the amount of streaming data specified in said streaming preload instruction.

5. A data processing apparatus according to claim 1, wherein
(i) each of said cache lines of said cache memory has associated therewith a valid bit used to indicate whether the cache line contains valid data;
(ii) said identification circuitry is operable to set the valid bit of a cache line to indicate that the cache line does not contain valid data if that cache line is preferred for reuse; and
(iii) said cache maintenance circuitry is operable to preferentially select for reuse cache lines having a valid bit which is set to indicate that that cache line does not contain valid data.

6. A data processing apparatus according to claim 1, wherein
(i) each of said cache lines of said cache memory has associated therewith a preferred for reuse field which is set in dependence on the preferred for reuse identification produced by the identification circuitry; and
(ii) said cache maintenance circuitry is operable to preferentially select for reuse cache lines having a preferred for reuse field which is set to indicate that that cache line is preferred for reuse.

7. A data processing apparatus according to claim 1, wherein
(i) said cache memory is an n-way set associative cache memory; and
(ii) said cache maintenance circuitry is operable to select between n corresponding cache lines of the respective n ways for reuse having regard to any preferred for reuse identification generated by said identification circuitry for any of the one or more of the n corresponding cache lines of the cache memory.

8. A data processing apparatus according to claim 7, comprising:
(i) a streaming data lookup table operable to store an association between previously cached lines of data values and an indication of in which of the n ways the lines of data values were cached;
(ii) wherein said identification circuitry is operable in response to said streaming preload instruction to locate the cache line of data values within said cache memory using said streaming data lookup table and identify the located cache line for preferential reuse; and
(iii) wherein said preload circuitry is operable to add an entry in said streaming lookup table to indicate to which way of the cache memory the preloaded data values have been stored.

9. A data processing apparatus according to claim 7, wherein
said identification circuitry is operable to locate the cache lines of data values within said cache memory by searching the cache memory for a cache line corresponding to the address of the one or more data values stored in the cache line.

10. A data processing apparatus according to claim 7, comprising:
(i) a streaming data lookup table operable to store an association between previously cached lines of data values and an indication of in which of the n ways the lines of data values were cached;
(ii) wherein said identification circuitry is operable to add an entry in said streaming lookup table to indicate to which way of the cache memory the preloaded data values have been stored; and
(iii) wherein said cache maintenance circuitry is operable to select between n corresponding cache lines of the respective n ways for reuse having regard to any entries in the streaming lookup table indicating any of the one or more of the n corresponding cache lines of the cache memory.

11. A data processing apparatus according to claim 10, wherein
said cache maintenance circuitry has regard to the least recently added entries in the streaming lookup table in selecting between the n corresponding cache lines of the respective n ways for reuse.

12. A data processing apparatus according to claim 2, wherein
said preload circuitry is operable to store into said cache memory data values corresponding to a portion of main memory containing the address
P_{add}=A_{curr}+x×Cₛ
and said identification circuitry is operable to identify for preferential reuse one or more cache lines of said cache memory containing data values corresponding to a portion of memory containing the address
R_{add}=A_{curr}−y×Cₛ
where P_{add} represents a memory address within the portion of main memory to be preloaded into the cache memory in the preload operation, R_{add} represents a memory address corresponding to a cache line to be identified for reuse in the reuse identification operation, A_{curr} represents the memory address specified in the streaming preload instruction, Cₛ represents the length of each cache line in the cache memory, and x and y are integers.

13. A data processing apparatus according to claim 12, wherein x and/or y are predetermined constants.

14. A data processing apparatus according to claim 12, wherein x and/or y are specified in said streaming preload instruction.

15. A data processing apparatus according to claim 1, comprising:
(i) a further cache memory provided between said main memory and said cache memory, said further cache memory having a plurality of cache lines operable to store data values for transfer to the cache memory and access by the processor when executing the sequence of instructions; wherein
(ii) said streaming preload instruction specifies in respect of which of said cache memory and said further cache memory the preload operation and the eviction identification operation are to be conducted; and
(iii) said cache controller is operable, in the case that said streaming preload instruction specifies that the preload operation and the reuse identification operation are to be conducted in respect of the cache memory, to preload data values into cache lines of the cache memory, and mark for reuse one or more cache lines of the cache memory,
(iv) and is operable, in the case that said streaming preload instruction specifies that the preload operation and the reuse identification operation are to be conducted in respect of the further cache memory, to preload data values into cache lines of the further cache memory, and mark for reuse one or more cache lines of the further cache memory.

16. A data processing apparatus according to claim 1, wherein said streaming preload instruction is executable by application software running on the data processing system in an unprivileged mode.

17. A data processing apparatus according to claim 1, wherein said cache maintenance operation is a line fill.

18. A data processing apparatus, comprising:
(i) processing means for executing a sequence of instructions;
(ii) cache memory means having a plurality of cache lines for storing data values for access by the processing means when executing the sequence of instructions;
(iii) cache control means, comprising
preload means for storing data values from a main memory into one or more cache lines of said cache memory means in response to a streaming preload instruction received at said processing means;
identification means for identifying one or more cache lines of said cache memory means for preferential reuse in response to said streaming preload instruction; and
cache maintenance means for implementing a cache maintenance operation during which selection of one or more cache lines for reuse is performed having regard to any preferred for reuse identification generated by said identification means for cache lines of the cache memory means.

19. A method of operating a cache memory having a plurality of cache lines for storing data values for access by a processor when executing a sequence of instructions, comprising the steps of:
(i) storing data values from a main memory into one or more cache lines of said cache memory in response to a streaming preload instruction received at said processor;
(ii) identifying one or more cache lines of said cache memory for preferential reuse in response to said streaming preload instruction; and
(iii) implementing a cache maintenance operation during which selection of one or more cache lines for reuse is performed having regard to any preferred for reuse identification generated by said identifying step for cache lines of the cache memory.
